(19) United States
(12) Patent Application Publication
(10) Pub. No.: US 2026/0289455 A1
(43) Pub. Date: Sep. 24, 2026

(54) Method for Checking Compliance with Conformity Requirements by an Agentic System of a Technical System

(71) Applicant: Robert Bosch GmbH, Stuttgart (DE)

(72) Inventor: Paul Sebastian Baireuther, Stuttgart (DE)

(21) Appl. No.: 19/573,956

(22) Filed: Mar. 20, 2026

(30) Foreign Application Priority Data
Mar. 21, 2025 (DE) 10 2025 111 095.6

(51) Int. Cl. G06Q 10/0631; G06F 16/334

(52) U.S. Cl. CPC G06Q 10/06316; G06F 16/334

(57) ABSTRACT

A method for checking compliance with conformity requirements by an agentic system of a technical system. Furthermore, a computer program, a device, and a storage medium for this purpose is also disclosed.

This application claims priority under 35 U.S.C. § 119 to patent application no. DE 10 2025 111 095.6, filed on Mar. 21, 2025 in Germany, the disclosure of which is incorporated herein by reference in its entirety.

The disclosure relates to a method for checking compliance with conformity requirements by an agentic system of a technical system. Furthermore, the disclosure relates to a computer program, a device, and a storage medium for this purpose.

### BACKGROUND

Agentic systems, as components for technical systems that make decisions and execute actions based on machine learning models, such as, for example, large language models (LLM), have the potential to (partially) automate almost any task or process that contains a component that may be executed by a computer. For example, all kinds of administrative and procurement processes, but also engineering and scientific tasks, teaching and assistance as well as creative and artistic tasks.

However, these agents are often not very reliable, and their effective monitoring is difficult and time-consuming. This makes their use in a company that strives for compliance and reliability extremely difficult.

### SUMMARY

The subject matter of the disclosure is a method, a computer program, a device, and a computer-readable storage medium having the features set forth below. Further features and details of the disclosure result from the description and the drawings. The features and details described in connection with the method according to the disclosure naturally also apply in connection with the computer program according to the disclosure, the device according to the disclosure, and the computer-readable storage medium according to the disclosure, and vice versa, such that a mutual reference is always possible with regard to the disclosure of the disclosure.

The subject matter of the disclosure is, in particular, a method for checking compliance with conformity requirements by an agentic system of a technical system, that is to say, in particular, it is to be checked whether the agentic system complies with the conformity requirements, comprising:
defining a task for the agentic system of the technical system, wherein for carrying out the defined task (preferably, inter alia), in particular, a use of a machine learning model of the agentic system is provided, wherein the machine learning model is, for example, a foundation model, preferably, a (large) language model, or a machine learning model comprising multiple modalities, in which at least one modality is language, for example, an image-language model, that is to say, a vision language model,
   wherein the machine learning model, in particular, in the context of the disclosure, is only used and not trained, that is to say, the machine learning model is preferably an already trained machine learning model specialized for the task class, or foundation model, wherein retraining or finetuning is not excluded,
providing at least one conformity requirement depending on the defined task, which is to be taken into account during performance of the defined task, wherein the at least one conformity requirement preferably is based on a legal or regulatory specification or a standard, wherein the at least one conformity requirement may be stored in an external database, for example in the form of checklists, in particular compliance checklists, wherein within the scope of the providing, a corresponding retrieval of the at least one conformity requirement from the external database may be initiated, wherein the at least one conformity requirement alternatively may also be created directly from a system message of the agentic system,
checking a communication of the agentic system within the scope of the defined task with regard to the at least one conformity requirement, wherein the communication of the agentic system is directed to a component of the technical system or to an external further technical system, for example via the external further technical system also to a user, wherein the communication may be, or may comprise, an output of the machine learning model, wherein the output comprises, for example, human language, images, a bit stream, a computer language, and/or control commands,
   wherein the following steps are performed when a result of the checking indicates a violation of the communication against the at least one conformity requirement:
blocking the communication, wherein the blocking may comprise redirecting the communication or may also comprise simply not permitting it.

If the result of the checking does not indicate a violation of the communication against the at least one conformity requirement, it may be provided that the communication is permitted to the component of the technical system or to the external further technical system. The result of the checking preferably comprises explanations why a respective conformity requirement has been fulfilled or violated. The agentic system comprises, in particular, at least one agent, which in turn preferably means the following: a software system that is capable of making decisions and executing actions. For making decisions and/or generating communications, the machine learning model, that is to say, in particular, a large language model and/or a vision-language model, may be used. For executing actions, corresponding functions may be made available to the agent. For example, the agent may be configured to control an email program such that texts previously created by the machine learning model, in particular, the large language model, are sent to an addressee. The machine learning model may thus, in particular, be a component of a respective agent. In connection with this disclosure, “agentic system” denotes a system that consists of one or more such agents. For example, the technical system may be a vehicle or a robot. The component may be, for example, a control system of the technical system, or of the vehicle or robot. The external technical system may be, for example, a data processing device with which the technical system may communicate. For example, it is conceivable that the external technical system is a data processing device of a supplier. The communication may be, for example, an email to the supplier, a computer instruction for triggering an action such as an order in an electronic ordering system, a reminder to a human or to an external further technical system, or also control commands to a machine such as a vehicle or a robot. Accordingly, based on the communication, an action of the component of the technical system or of the external further technical system may be initiated.

The method according to the disclosure may thus advantageously check whether an agentic system of a technical system, in particular, a machine-learning-based agentic system, operates in accordance with relevant laws, regulations, and standards.

It may be provided within the scope of the disclosure that the method further comprises:
extracting keywords that describe the defined task, for example, by the machine learning model, in particular, language model, or by a further machine learning model, in particular, language model,
   wherein the providing of the at least one conformity requirement is performed based on the extracted keywords, preferably by initiating, based on the extracted keywords, a retrieval of the at least one conformity requirement from an (external) database. The database may alternatively also be an internal database of the technical system. In other words, the extracted keywords may be used as search terms for retrieval from the (external) database. By way of the extracted keywords it may advantageously be determined which conformity requirements are relevant for the defined task.

It may be provided that the method further comprises the following step when the result of the checking indicates the violation of the communication against the at least one conformity requirement:
reporting back the blocking and/or the result of the checking to the agentic system, for example in the form of an error message, wherein here it may further be provided that an output of a message or warning to a user of the technical system is initiated, wherein reporting back the blocking expressed in simplified terms in particular means that it is reported back that the communication has been blocked.

According to a further possibility, it may be provided that the checking of the communication is performed individually for individual conformity requirements, in particular, individually for all conformity requirements. This has the advantage that, in general, the checking of one requirement is simpler than the simultaneous checking of multiple requirements. As a result, it may advantageously be checked whether each of the conformity requirements is actually fulfilled.

It may be provided that, within the scope of the checking, an interface of the agentic system or of the technical system is monitored and, within the scope of the blocking, the interface is deactivated. The deactivation may be carried out reversibly and only for a defined period of time, or the deactivation may concern only the communication, that is to say, for example, an individual message. The interface may be a virtual interface, that is to say, an interface present in software, or also a physical wired or wireless interface.

Furthermore, it may be provided within the scope of the disclosure that the method, when at least two conformity requirements are provided, further comprises:
checking the at least two conformity requirements for freedom from contradictions.

This has the advantage that integrity and/or coherence of the conformity requirements is ensured. This may lead to higher quality and/or reliability of the method. Furthermore, by checking the conformity requirements for freedom from contradictions, errors and inconsistencies may be avoided. In particular, an execution, taking into account two contradictory requirements, should not be possible. Unless only one of the contradictory requirements is relevant for the task.

For example, it may be provided that the method further comprises:
initiating a documentation of the communication and/or of the result of the checking in a database.

The documentation enables, in particular, transparent verification and facilitates proof of compliance, that is to say, of fulfillment, or at least of checking, of the at least one conformity requirement. Furthermore, the database may be used for the analysis of patterns and trends in order to improve the effectiveness of the method according to the disclosure. In particular, retraining of the machine learning model (“fine-tuning”) may be provided here.

It is also optionally conceivable that the method further comprises:
modifying the communication on the basis of the reported result, in particular, by the agentic system, or by the agent of the agentic system which has generated the communication.

By modifying the communication, secure and compliant behavior of the technical system may be achieved by, for example, removing non-conforming data from the communication or adapting them taking into account the reported result, that is to say, in particular, the non-fulfilled conformity requirement. This may advantageously result in the technical system subsequently being able to operate in accordance with the conformity requirements.

It may optionally be possible that the communication comprises control commands for the technical system and the following step is performed when a result of the checking does not indicate a violation of the communication against the at least one conformity requirement:
initiating control of the technical system based on the communication.

For example, the control may implement a planned trajectory for a vehicle or a robot as a technical system. Thus, it may advantageously be ensured that the planned trajectory is first checked with regard to the at least one conformity requirement before it is used for actual control of the technical system, which, in addition to the checking of compliance with the conformity requirement, may also increase efficiency and/or safety of the technical system.

It is possible that the method according to the disclosure is used in a vehicle. The vehicle may be configured, for example, as a motor vehicle and/or passenger car and/or at least partially automated or autonomous vehicle. The vehicle may have a vehicle device, for example, for providing an autonomous driving function and/or a driver assistance system. The vehicle device may be configured to control the vehicle at least partially automatically and/or to accelerate and/or to brake and/or to steer the vehicle.

Also the subject matter of the disclosure is a computer program, in particular, a computer program product, comprising instructions which, when the computer program is executed by at least one computer, cause the latter to carry out the method according to the disclosure. Thus, the computer program according to the disclosure brings about the same advantages as have been described in detail with reference to a method according to the disclosure.

Also the subject matter of the disclosure is a data processing device which is configured to carry out the method according to the disclosure. As the device, for example, at least one computer may be provided that executes the computer program according to the disclosure. The computer may comprise at least one processor for executing the computer program. Also, a non-volatile data memory may be provided in which the computer program is stored and from which the computer program may be read out by the processor for execution.

Also subject matter of the disclosure may be a computer-readable storage medium which has the computer program according to the disclosure and/or comprises instructions which, when executed by at least one computer, cause the latter to carry out the method according to the disclosure. The storage medium is configured, for example, as a data memory such as a hard disk and/or a non-volatile memory and/or a memory card. The storage medium may, for example, be integrated in the computer.

Furthermore, the method according to the disclosure may also be configured as a computer-implemented method. Alternatively or additionally at least one of the disclosed method steps may be computer implemented and/or performed automatically.

### BRIEF DESCRIPTION OF THE DRAWINGS

Further advantages, features, and details of the disclosure result from the following description in which exemplary embodiments of the disclosure are described in detail with reference to the drawings. Features mentioned in the claims and in the description may each, individually on their own or in any desired combination, be essential to the disclosure. It shows:

FIG. 1 a schematic visualization of a method, a device, a storage medium, and a computer program according to exemplary embodiments of the disclosure,

FIG. 2 a schematic representation of a technical system, an external further technical system, and an agentic system comprising a machine learning model according to exemplary embodiments of the disclosure.

### DETAILED DESCRIPTION

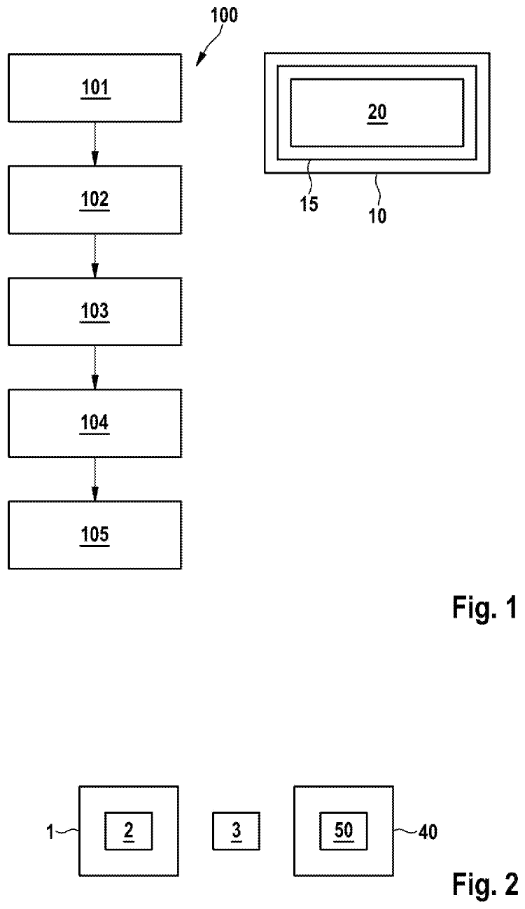

In FIG. 1 a method 100, a device 10, a storage medium 15, and a computer program 20 according to exemplary embodiments of the disclosure are schematically represented.

FIG. 1, in particular, shows an exemplary embodiment for a method 100 for checking compliance with conformity requirements by an agentic system 40 of a technical system 1. In a first step 101, a task for the agentic system 40 of the technical system 1 is defined, wherein, for carrying out the defined task, in particular, a use of a machine learning model 50 of the agentic system 40 is provided. It may be that the agentic system may carry out only a part of the task itself and, for example, the technical system is also necessarily required for execution. In a second step 102, at least one conformity requirement is provided as a function of the defined task, which is to be taken into account in carrying out the defined task, wherein the at least one conformity requirement preferably is based on a statutory or regulatory provision or a standard. In a third step 103, a communication of the agentic system 40 within the scope of the defined task is checked with regard to the at least one conformity requirement, wherein the communication of the agentic system 40 is directed to a component 2 of the technical system 1 or to an external further technical system 3. The following steps are carried out when a result of the checking 103 indicates a violation of the communication against the at least one conformity requirement. In a fourth step 104 the communication is blocked. In an optional fifth step 105, the blocking 104 and the result of the checking 103 may be reported back to the technical system 1.

FIG. 2, in particular, shows a schematic representation of a technical system 1 with a component 2, an external further technical system 3, and an agentic system 40 comprising a machine learning model 50. The agentic system 40 may be surrounded by a compliance shield, which is provided, in particular, for checking the communication of the agentic system 40 within the scope of the defined task with regard to the at least one conformity requirement. It may be intended that the machine learning model 50 is executed on a server and is controlled by way of an application programming interface (API).

In this disclosure, the focus is, in particular, on agentic systems which may comprise an LLM, the field of use of which, however, may be substantially more versatile than that of an LLM. In particular, cooperation of a plurality of agents (that is to say, subsystems) may occur, each using an LLM. Such systems may be particularly susceptible to errors due to their complexity. This disclosure describes an automated method that may increase the reliability of agentic systems. Communication of an agentic system is compared with task-specific conformity requirements, optionally prevented, and an improvement of the communication is automatically requested. In particular, the selection of the conformity requirements may be carried out automatically, based on the task, and does not have to be carried out manually by a human. This may be particularly advantageous when the field of application of the agentic system, and thus the number of possible tasks, is large.

According to exemplary embodiments of the disclosure, in particular, enforcement of compliance and/or fulfillment of a duty of care in a technical system 1 is sought. The method according to the disclosure aims, in particular, to enforce compliance with laws, regulations, and guidelines for an agentic system of the technical system and, preferably, also to document this, even when the agentic system is a black box system whose internal structure and mechanisms are unknown.

Furthermore, in one variant, the disclosure may also be used to make an agentic system 40 with a machine learning model 50, in particular, a large language model (LLM), more reliable. A compliance checklist may, in particular, be created automatically by a language model or by the machine learning model 50 on the basis of a system message of the at least one agent of the agentic system 40, that is to say, in particular, the part of the LLM prompt that defines the agent, for example, “You are an expert in accounting, your task is to fulfill the following task in compliance with rule 1: . . . ”, and/or from the defined task. Then, the method according to the disclosure may be used to increase the probability that the agentic system reliably complies with its own system message(s) and/or the defined task. An entry of the automatically created compliance checklist could, in this case, be the following: “The communication of the agent, or of the agentic system 40, observes rule 1.”

According to exemplary embodiments of the disclosure, various components of a compliance system may be used within the scope of the method. A compliance platform may be provided, as well as a compliance administrator and a compliance shield, and an agentic system 40, which may comprise, in particular, the machine learning model 50. The compliance platform comprises, for example, a database, a self-consistency checker, and a workflow. The database preferably comprises compliance checklists, that is to say, lists having various conformity requirements. The self-consistency checker determines, in particular, whether a set of conformity requirements is self-consistent, that is to say, free from contradictions. The workflow preferably involves corresponding human experts if self-consistency is violated or compliance checklists are missing. The compliance administrator may, for example, be an agentic system which may, in particular, use an LLM and may be equipped with a communication interface and/or a database connection and/or a search function. The compliance administrator analyzes, for example, a defined task, queries the compliance platform for the corresponding compliance checklists, transfers these compliance checklists to the compliance shield, instructs the agentic system 40 to perform the task, optionally supplemented by the compliance checklists, and preferably finally documents the compliance, that is to say, fulfillment of the compliance checklists. The compliance shield according to the disclosure may be a wrapper around a (black box) agentic system 40, that is to say, in particular, the machine learning model. The compliance shield may, for example, be an agentic system which is equipped with a communication interface and which may, in particular, use an LLM. In this case, this agentic system is advantageously configured to be as simple as possible in order to achieve the highest possible reliability. For example, the compliance shield may comprise only a single agent. If violations are detected, corresponding feedback may be provided to the agentic system 40 and a revision may be requested. According to the disclosure, fulfillment of the compliance checklists by the communication of the agentic system 40 may thus be made more likely. If no violations with regard to the compliance checklists are detected, explanations are preferably provided to the compliance administrator as to why each item of the compliance checklists is fulfilled. Furthermore, the communication, that is to say, for example, messages or instructions, of the agentic system 40 to the environment, for example, to a component or interface of a technical system, may be forwarded.

In one variant of the method according to the disclosure, the following steps may be provided: Based on a defined task, relevant compliance checklists may first be queried, for example, by the compliance administrator from the compliance platform. The task may, for example, be defined by a user in text form. These compliance checklists may now be forwarded by the compliance administrator to the compliance shield.

The agentic system 40 may now be commissioned with carrying out the defined task, for example, by the compliance administrator. Subsequently, the agentic system 40 may undertake a step for solving the task that involves a communication with an environment, that is to say, in particular, directed to a component of the technical system or to an external further technical system. It is now preferably checked, in particular, by the compliance shield according to the disclosure, whether the communication is in accordance with the compliance checklists, or whether the corresponding conformity requirements are fulfilled. If yes, the compliance shield preferably communicates its decision, including corresponding reasons, to the compliance administrator and forwards the communication through the compliance shield to the environment. If not, feedback is preferably provided to the agentic system 40 and a revision of the communication is requested.

In a more extensive variant of the method according to the disclosure, the following steps may be provided: Starting from a defined task, relevant compliance checklists may initially be queried. A machine learning model, such as an LLM, may be used to extract task-describing keywords, and the compliance administrator may perform a search in the compliance platform database based on the keywords. The relevant compliance checklists may further be analyzed to detect contradictions. If contradictions exist, this may be reported to human experts, who either decide that the process may not be carried out in a compliant manner, or adjust the compliance checklists in order to resolve the contradictions. In order to convert existing regulations into checklists, a machine learning model, such as an LLM, may be employed to support the human experts.

The compliance administrator now preferably forwards the compliance checklists to the compliance shield. The compliance administrator may now instruct the agentic system 40 to perform the task. The compliance administrator may further supplement the task description with the items of the compliance checklists before transmitting it to the agentic system 40. The agentic system 40 preferably now performs a step for solving the task, which comprises communication with the environment, that is to say, for example, directed to a component of the technical system or to an external further technical system. The communication may be, for example, an email to a supplier, a computer instruction for triggering an order in an electronic ordering system, a reminder to a human or to a system, a control command to a machine or a robot, etc. The compliance shield and the compliance administrator may be completely unaware of the internal workings of the agentic system 40. The only requirement is, in particular, that the compliance shield according to the disclosure may shield, that is to say, block, an output, that is to say, the communication, of the agentic system 40. Advantageously, the agentic system 40 may be capable of receiving feedback. Now, in particular, by the compliance shield, it may be checked whether a content of the communication is in accordance with the compliance checklists, that is to say, does not contradict them. This check is preferably carried out individually for each element, that is to say, for each conformity requirement. The compliance shield according to the disclosure may comprise a machine learning model, in particular, an LLM, in order to automate the verification and to provide explanations as to why a respective conformity requirement has been fulfilled or violated. If compliance with the conformity requirements described in the compliance checklists is fulfilled, the compliance shield preferably communicates its decision including the reasons to the compliance administrator responsible for documenting compliance. Compliance with the conformity requirements may be documented, for example, as a text document in a database, such that it may be easily verified if, despite the check, an undesired behavior of the agentic system or of the technical system occurs, and for auditing purposes. If a violation of compliance is detected, that is to say, the conformity requirements are not fulfilled, the compliance shield blocks the outgoing communication of the agentic system and preferably provides feedback to the agentic system 40 and requests a revision of the communication. The feedback may comprise the violated conformity requirement or requirements, the original task definition, and/or the explanation of the compliance shield of what constitutes the violation. If a maximum number of, in particular, consecutive non-conforming communications has been reached, a human may be involved and/or the execution of the task may be terminated. The compliance administrator preferably documents the communication, the compliance, and/or a possible reaction of the environment, wherein the environment may, in particular, mean the component of the technical system or the further external technical system.

Possible applications in technology, engineering, and design are described below.

The method according to exemplary embodiments of the disclosure may be used, for example, to create a more reliable high-level control unit for a technical system such as a robot.

High-level control units plan action sequences, in particular, at a relatively abstract level. Control units of the middle level convert these actions, in particular, into finer steps, and control units of the lower level implement these finer actions by controlling actuators and other physical devices.

According to a first example, the method of the disclosure is used for a worksite robot. A typical task may consist in drilling a hole with predefined specifications into a wall at a particular location. The plan created by the higher-level control unit may appear as follows: Mounting a drill bit suitable for the drilling, approaching the predefined position, drilling the hole at the predefined position, removing the drill bit. Like a human worker, however, the robot should comply with conformity requirements based on laws, regulations, and best practices. For example, a specification may be that the indicated position is not located above an electrical switch, that the wall at the indicated position is not obstructed, and/or that there is nothing unprotected nearby that could be damaged by debris generated during the drilling. Even if the higher-level control unit takes the conformity requirements into account in its planning, errors may increase with an increasing number of conformity requirements. One reason for this is, in particular, that the plan must take all conformity requirements into account simultaneously, which may render the planning task complex and error-prone. With the method according to exemplary embodiments of the disclosure, the plan, that is to say, the communication of the agentic system of the higher-level control unit, is checked for compliance with the conformity requirements before execution, in particular, one conformity requirement after the other.

According to a further example, the method of the disclosure may be applied to an autonomous vehicle. A typical task may consist in performing a lane change to the left. The agentic system of the higher-level control unit may create a plan, for example: checking whether there is no further vehicle on the left, activating the turn signal, defining a trajectory, checking again for vehicles/obstacles in the trajectory, performing the lane change, deactivating the turn signal. However, there are, in particular, a number of conformity requirements that must additionally be fulfilled, such as, for example: The left lane must lead in the same direction as the current lane, crossing must not be prohibited by a solid line, the left lane must be sufficiently wide in the case of a large vehicle, etc. As in the previous application example, the sheer number of conformity requirements renders the planning task, in particular, complex and error-prone. Here, too, more reliable planning may be achieved in that the conformity requirements are checked individually according to the disclosure and, upon detecting a violation, the plan is not executed but, in particular, taking into account the description of the violation, the agentic system is tasked with improving the plan.

According to a further example, the method of the disclosure may be applied to a robot assistant. By interacting with the general public, the robot assistant must, in particular, comply with both laws and social rules. A highly complex task, which may in turn be carried out more reliably with the method according to the disclosure.

Furthermore, the method according to exemplary embodiments of the disclosure may be used to increase a probability that a product-development agent complies with the applicable rules of product development. With the method according to exemplary embodiments of the disclosure, a product plan may be automatically compared sequentially with all applicable conformity requirements and may then be improved based on a result of the comparison. In particular, it is conceivable that the disclosure may be advantageously used in order to render a system-design agent for component design more reliable. Components may, in particular, be MEMS sensors.

Furthermore, the method according to exemplary embodiments of the disclosure may be used to increase a probability that a technical drawing produced by a design agent fulfills all requirements. With the aid of an image-language model, that is to say, a vision language model, it may, for example, be checked whether all aspects of the task specification and all conformity requirements of a technical drawing are fulfilled, and specifically one requirement after the other. Feedback may then be provided to the design agent, in particular, repeatedly, until all requirements are fulfilled or until the design process is terminated after a predefined number of iterations.

The foregoing explanation of the embodiments describes the present disclosure exclusively within the context of examples. Of course, individual features of the embodiments may, if technically meaningful, be freely combined with one another without departing from the scope of the present disclosure.

What is claimed is:

1. A method for checking compliance with conformity requirements by an agentic system of a technical system, comprising:
defining a task for the agentic system of the technical system, wherein for carrying out the defined task a use of a machine learning model of the agentic system is provided;
providing at least one conformity requirement as a function of the defined task, which is to be taken into account when performing the defined task;
checking a communication of the agentic system in the context of the defined task with regard to the at least one conformity requirement, wherein the communication of the agentic system is directed to a component of the technical system or to an external further technical system; and
wherein the following steps are performed when a result of the checking indicates a violation of the communication against the at least one conformity requirement:
blocking of communication.

2. The method according to claim 1, further comprising:
extracting keywords that describe the defined task,
wherein the providing of the at least one conformity requirement is performed based on the extracted keywords by initiating, based on the extracted keywords, a retrieval of the at least one conformity requirement from a database.

3. The method according to claim 1, further comprising:
when the result of the checking indicates the violation of the communication against the at least one conformity requirement:
reporting back the blocking and/or the result of the checking to the agentic system.

4. The method according to claim 1, wherein:
the checking of the communication is performed individually for individual conformity requirements.

5. The method according to claim 1, wherein:
an interface of the agentic system is monitored as part of the testing and the interface is deactivated as part of the blocking.

6. The method according to claim 1, further comprising:
when at least two conformity requirements are provided, checking the at least two conformity requirements for freedom from contradictions.

7. The method according to claim 1, further comprising:
initiating documentation of the communication and/or of the result of the checking in a database.

8. The method according to claim 1, further comprising:
modifying the communication on the basis of the reported result.

9. The method according to claim 1, wherein:
an action of the component of the technical system or of the external further technical system is initiated on the basis of the communication.

10. The method according to claim 1, wherein:
the communication comprises control commands for the technical system, and
the following step is carried out when a result of the checking indicates no violation by the communication of the at least one conformity requirement:
initiating control of the technical system based on the communication.

11. A computer program, comprising instructions that, when the computer program is executed by at least one computer, cause the computer to perform the method according to claim 1.

12. A device for data processing that is configured to perform the method according to claim 1.

13. A computer-readable storage medium, comprising instructions that, when executed by at least one computer, cause the computer to perform the steps of the method according to claim 1.

14. The method according to claim 1, wherein:
the checking of the communication is performed individually for all conformity requirements.
